(19) United States
(12) Patent Application Publication
(10) Pub. No.: US 2020/0386719 A1
(43) Pub. Date: Dec. 10, 2020

(54) MULTI-FUNCTIONAL ULTRASONIC PHASED ARRAY IMAGING DEVICE

(71) Applicant: KOREA RESEARCH INSTITUTE OF STANDARDS AND SCIENCE, Daejeon (KR)

(72) Inventors: Choon-Su PARK, Dajeon (KR); Sae Won HONG, Hwaseong-si (KR); Young Ho LEE, Hwaseong-si (KR)

(21) Appl. No.: 16/772,507

(22) PCT Filed: Oct. 18, 2018
(86) PCT No.: PCT/KR2018/012307

§ 371 Date: Jun. 12, 2020

(30) Foreign Application Priority Data
Dec. 12, 2017 (KR) 10-2017-0169913

(51) Int. Cl. G01N 29/24; G01N 29/06; G01N 29/34

(52) U.S. Cl. CPC G01N 29/2437; G01N 2291/0289; G01N 29/348; G01N 29/069

(57) ABSTRACT

The present invention relates to a complex multi-frequency ultrasonic phased array imaging device comprising: a transducer, which transmits a phased array ultrasonic signal to an object to be inspected, receives an ultrasonic signal reflected from the object to be inspected, and includes at least one first piezoelectric element having a high resonance frequency and second piezoelectric element having a resonance frequency lower than that of the first piezoelectric element; a control unit for controlling operations of the first piezoelectric element and the second piezoelectric element by applying an operation signal to the transducer; and a portable imaging unit, which calculates an operation signal applied from the control unit and an ultrasonic signal received in the transducer as a delay-sum for a phased array image, thereby outputting the same as a phased array image.

### TECHNICAL FIELD

The present invention is about complex multi-frequency ultrasonic phased array imaging device.

### BACKGROUND ART

Non-destructive testing is a method of inspecting internal defects or a surface state of a workpiece without causing deformation of or damage to the workpiece in the field of manufacturing. Methods of non-destructive testing include liquid-penetrant testing, magnetic-particle inspection, acoustic-emission testing, acoustic-impact testing, radiography, eddy-current testing, thermal inspection, a holography technique, and ultrasonic testing is also one of the non-destructive inspection.

Ultrasonic testing is a method of examining the inside of an object to be inspected by transmitting an ultrasonic wave to the inside of the object to be inspected, receiving an ultrasonic wave reflected from the inside of the object to be inspected, and making images with received ultrasonic wave. In the early stage, ultrasonic testing was mainly used to examine the inside of a human body without incision. Objects to be inspected may also be inspected in the same manner, and therefore, recently, the ultrasonic testing has been widely used in the industrial field to determine whether or not defects present in the workpiece, or to reveal the type of the defect, when there are defects.

In the ultrasonic testing, a device called transducers which transmit and receive ultrasonic waves are inevitable. Transducers includes piezoelectric elements for transmission and reception of ultrasonic waves. The transducers may be classified as linear array transducer, curvilinear array transducer, annular array transducer, matrix array transducer, or the like depending on an array form of the piezoelectric elements included in the transducer, and a phased array transducer is a concept including those described above.

Since a control to, for example, change a point where an ultrasonic signal is concentrated according to a position to be measured by causing the transducer to transmit ultrasonic signals with corresponding phase differences to variously controlled delay times for piezoelectric elements of each of the various types of transducers may be performed, the phased array transducers have been used in various fields including imaging.

In general, in a single phased array transducer, piezoelectric elements have the same resonance frequency and in the case of having the same resonance frequency, only an image with a limited resolution may be ontained. Therefore, it limits availability depending on the type or size of defects in the object to be inspected in many cases, and some defects could not be detected from linear phased array imaging.

### DISCLOSURE

### Technical Problem

An object of the present invention is to provide a complex multi-frequency ultrasonic phased array imaging device which generates linear and non-linear images with various resolutions by using piezoelectric elements having various types of resonance frequencies to enable detection of various types of defects formed in an object to be inspected.

### Technical Solution

In one general aspect, a complex multi-frequency ultrasonic phased array imaging device includes: a transducer configured to transmit a phased array ultrasonic signal to an object to be inspected, receive an ultrasonic signal reflected from the object to be inspected, and include at least one first piezoelectric element having a high resonance frequency and at least one second piezoelectric element having a resonance frequency lower than that of the first piezoelectric element; a control unit configured to apply an operation signal to the transducer to control operations of the first piezoelectric element and the second piezoelectric element; and a portable imaging unit configured to calculate the operation signal applied from the control unit and the ultrasonic signal received by the transducer as a delay-sum for a phased array imaging to output the received ultrasonic signal as a phased array image.

A plurality of first piezoelectric elements and a plurality of second piezoelectric elements may be arranged in a predetermined pattern.

The first piezoelectric element and the second piezoelectric element may be alternately arranged.

A resonance frequency of the first piezoelectric element may be a positive integer multiple of a resonance frequency of the second piezoelectric element.

The control unit may apply the operation signal to the transducer to control only one of the first piezoelectric element or the second piezoelectric element to transmit and receive the ultrasonic signal.

The control unit may apply the operation signal to the transducer to control only one of the first piezoelectric element or the second piezoelectric element to transmit the ultrasonic signal, and to control the other piezoelectric element that does not transmit the ultrasonic signal to receive the reflected ultrasonic signal.

The portable imaging unit may output a harmonic phased array image in a case where the first piezoelectric element transmits the ultrasonic signal and the second piezoelectric element receives the ultrasonic signal.

The portable imaging unit may output a subharmonic phased array image in a case where the second piezoelectric element transmits the ultrasonic signal and the first piezoelectric element receives the ultrasonic signal.

### Advantageous Effects

According to the complex multi-frequency ultrasonic phased array imaging device according to the present invention as described above, since only one of the first piezoelectric element or the second piezoelectric element transmits and receives an ultrasonic wave, the first piezoelectric element and the second piezoelectric element having different resonance frequencies, respectively, and an image is generated by using the received ultrasonic signal, it is possible to output images of an object to be inspected having different resolutions, thereby detecting various types of defects.

Further, according to the present invention, the first piezoelectric element having a high resonance frequency may transmit an ultrasonic wave, the second piezoelectric element having a low resonance frequency may receive an ultrasonic wave reflected from an object to be inspected, and a non-linear harmonic examination image of the object to be inspected may be output by using the received ultrasonic signal, such that it is possible to detect various types of defects that may not be detected by using the linear imaging technique.

Further, according to the present invention, the second piezoelectric element having a low resonance frequency may transmit an ultrasonic wave, the first piezoelectric element having a high resonance frequency may receive an ultrasonic wave reflected from an object to be inspected, and a sub-harmonic examination image of the object to be inspected may be output by using the received ultrasonic signal, such that it is possible to detect various types of defects that may not be detected by using the linear imaging technique.

### DESCRIPTION OF DRAWINGS

FIG. 1 is a schematic diagram illustrating a first exemplary embodiment of the present invention.

FIG. 2 is a schematic diagram illustrating the first exemplary embodiment of the present invention.

FIG. 3 is a schematic diagram illustrating a first operation mode according to the first exemplary embodiment of the present invention.

FIG. 4 is a schematic diagram illustrating a second operation mode according to the first exemplary embodiment of the present invention.

FIG. 5 is a schematic diagram illustrating a third operation mode according to the first exemplary embodiment of the present invention.

FIG. 6 is a schematic diagram illustrating a fourth operation mode according to the first exemplary embodiment of the present invention.

### BEST MODE

Hereinafter, a complex multi-frequency ultrasonic phased array imaging device according to preferred exemplary embodiments of the present invention will be described in detail with reference to the accompanying drawings.

### First Exemplary Embodiment

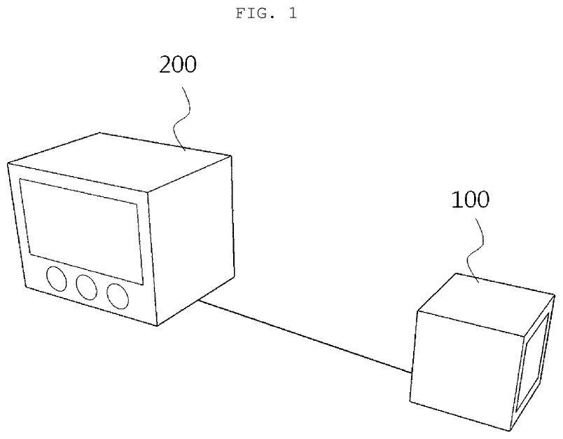

FIG. 1 schematically illustrates a first exemplary embodiment of the present disclosure.

As illustrated in FIG. 1, a complex multi-frequency ultrasonic phased array imaging device according to a first exemplary embodiment of the present invention may include a transducer 100, a control unit (not illustrated), and a portable imaging unit 200.

The transducer 100 illustrated in FIG. 1 transmits a phased array ultrasonic signal to an object to be inspected, and receives an ultrasonic signal reflected from the object to be inspected. That is, the transducer 100 is disposed close to or comes into contact with the object to be inspected. In FIG. 1, the transducer 100 has a rectangular parallelepiped shape, but the present invention is not limited thereto. The transducer may have various shapes depending on a target of an object to be inspected.

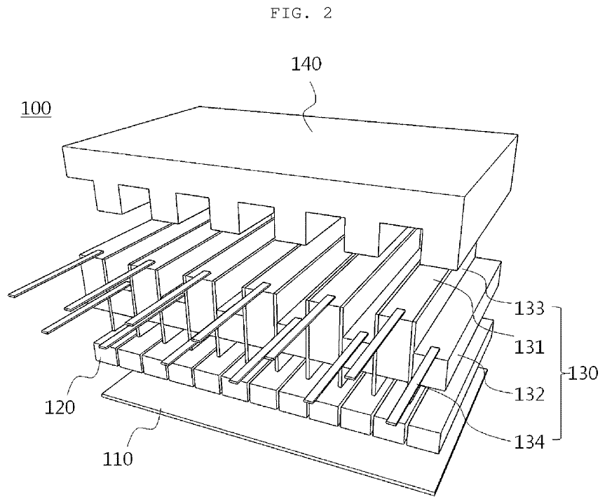

FIG. 2 is an exploded view illustrating the transducer 100.

As illustrated in FIG. 2, the transducer 100 may include an acoustic lens 110, a front matching layer 120, a vibrator unit 130, and a back layer 140.

The acoustic lens 110, the front matching layer 120, and the back layer 140 illustrated in FIG. 2 are components that are also included in a phased array transducer according to the related art. The respective components will be briefly described and then the vibrator unit 130 that is a feature of the first exemplary embodiment of the present invention will be described in detail.

The acoustic lens 110 is to minimize a loss of an ultrasonic wave transmitted through the acoustic lens 110, and may be formed of various materials. The acoustic lens 110 comes into contact with or is disposed close to the object to be inspected. The acoustic lens 110 is formed of a soft material and thus may be deformed along a curve of a surface of the object to be inspected to correspond to various shapes of the object to be inspected.

The front matching layer 120 is positioned between the acoustic lens 110 and the vibrator unit 130 and provides acoustic impedance matching between the vibrator unit 130 and the object to be inspected, thereby transferring an ultrasonic wave generated in the vibrator unit 130 or reducing a loss of a reflected signal from the object to be inspected. That is, the front matching layer 120 serves as a kind of buffer that solves a problem such as image distortion due to a rapid change in acoustic impedance between the vibrator unit 130 and the object to be inspected. The front matching layer 120 may be formed in each of the piezoelectric elements included in the vibrator unit 130.

The back layer 140 is formed outside the vibrator unit 130, and may facilitate acoustic impedance matching with the vibrator unit 130, and may have a sound absorption characteristic.

The vibrator unit 130 is a portion where substantial transmission and reception of an ultrasonic wave is made, and may include vibrators that transmit and receive an ultrasonic wave by using various methods. However, according to an exemplary embodiment of the present invention, the vibrators included in the vibrator unit 130 may include a first piezoelectric element 131 and a second piezoelectric element 132 as illustrated in FIG. 2. That is, the vibrator is the piezoelectric element in the first exemplary embodiment of the present invention, but the type of the vibrator is not limited to the piezoelectric element.

The first piezoelectric element 131 and the second piezoelectric element 132 have different resonance frequencies, respectively. More specifically, a resonance frequency f1 of the first piezoelectric element 131 is higher than a resonance frequency f2 of the second piezoelectric element 132, and the resonance frequency f1 may be a positive integer multiple of the resonance frequency f2.

As illustrated in FIG. 2, the first piezoelectric element 131 and the second piezoelectric element 132 are alternately arranged. However, the present invention is not limited thereto, and the first piezoelectric element 131 and the second piezoelectric element 132 may be arranged in a form in which a predetermined pattern is repeated. As an example of another pattern in which the first piezoelectric element 131 and the second piezoelectric element 132 are formed, a pattern in which two first piezoelectric elements 131 are consecutively arranged, and then two second piezoelectric elements 132 are consecutively arranged may be repeated.

A protective film 133 may be formed between the first piezoelectric element 131 and the second piezoelectric element 132 to prevent separation or crack caused by repetitive deformation, and the protective film 133 may be formed of a polymer material or may be formed integrally with the back layer.

As illustrated in FIG. 2, a wire 134 is formed on each of the first piezoelectric element 131 and the second piezoelectric element 132. The wire 134 is for transmission and reception of an operation signal and an ultrasonic signal to and from the control unit, and may be physically connected to the control unit.

As illustrated in FIG. 2, the first piezoelectric element 131 and the second piezoelectric element 132 may be different in size (height in FIG. 2) due to the difference in resonance frequency. To cover the difference in size, predetermined protrusions may protrude from the back layer 140 toward the piezoelectric element, the first piezoelectric element 131 may be inserted between the respective protrusions, and a protruding surface of the protrusion may be in contact with one surface of the second piezoelectric element 132.

The control unit applies the operation signal to the transducer 100 to control operations of the first piezoelectric element 131 and the second piezoelectric element 132. The operation signal applied from the control unit to the transducer 100 may cause the first piezoelectric element 131 or the second piezoelectric element 132 to transmit an ultrasonic wave to the object to be inspected, and may cause the first piezoelectric element 131 or the second piezoelectric element 132 to receive an ultrasonic wave reflected from the object to be inspected.

The control unit may be implemented by an embedded printed circuit board (PCB) mounted in the portable imaging unit 200 to be described later, or may be implemented in a form of software.

The portable imaging unit 200 is connected to the transducer 100, receives the operation signal applied from the control unit to the transducer 100 and the ultrasonic signal received by the transducer 100, calculates the operation signal and the received ultrasonic signal as a delay-sum for a phased array imaging, and outputs the received ultrasonic signal as a phased array image. The portable imaging unit 200 may include a calculation device and program for calculation of a phased array image therein, and a display may be formed on an outer surface of the portable imaging unit 200 to output an image.

Hereinafter, first to fourth operation modes which are different in regard to the operation signal applied from the control unit and the operations of the first piezoelectric element and the second piezoelectric element according to the operation signal will be described in detail with reference to the drawings.

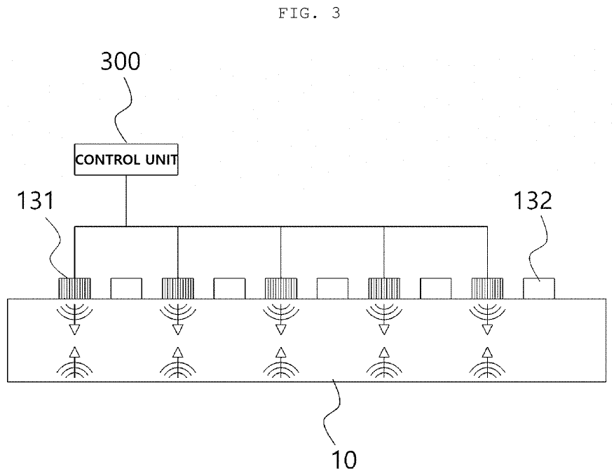

FIGS. 3 to 6 each schematically illustrate the first piezoelectric element 131 and the second piezoelectric element 132 included in the transducer, and the control unit connected to each piezoelectric element. FIG. 2 illustrates a case where the first piezoelectric element 131 and the second piezoelectric element 132 are different in size. However, for convenience, in FIGS. 3 to 6, the first piezoelectric element 131 and the second piezoelectric element 132 are the same in size, the first piezoelectric element 131 is indicated by hatching with diagonal lines, the second piezoelectric element 132 is indicated by hatching with vertical lines, and the first piezoelectric element 131 and the second piezoelectric element 132 are also distinguished by reference numerals thereof.

[First Operation Mode and Second Operation Mode]

In the first operation mode illustrated in FIG. 3, an ultrasonic wave is transmitted and received only by using the first piezoelectric element 131 to generate a linear ultrasonic phased array image.

For the operation in the above-described first operation mode, a control unit 300 applies an operation signal to the first piezoelectric element 131 to excite the first piezoelectric element 131, and the first piezoelectric element 131 transmits an ultrasonic signal to an object 10 to be inspected. Here, ultrasonic signals applied to the first piezoelectric element 131 may have a predetermined phase difference.

The ultrasonic signal transmitted from the first piezoelectric element 131 is transmitted through the object 10 to be inspected, and then is reflected from a bacwall (a distal end of the object to be inspected) of the object to be inspected, the reflected ultrasonic signal is received by the first piezoelectric element 131, the control unit 300 transmits the received ultrasonic signal to the portable imaging unit 200, and the portable imaging unit 200 generates and outputs a phased array image with reference to the received ultrasonic signal and the operation signal applied from the control unit 300 to the first piezoelectric element 131. The phased array image generated by and output from the portable imaging unit 200 is a linear phased array image.

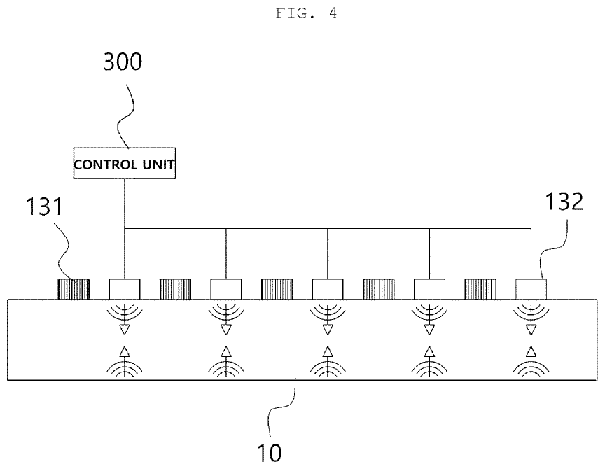

In the second operation mode illustrated in FIG. 4, similarly to the first operation mode, an ultrasonic wave is transmitted and received only by using the second piezoelectric element 132 to output a linear ultrasonic phased array image.

In the first operation mode and the second operation mode, the linear ultrasonic phased array image may be generated by using only the first piezoelectric element 131 or the second piezoelectric element 132, the first piezoelectric element 131 and the second piezoelectric element 132 having different resonance frequencies, respectively. The resonance frequency of the first piezoelectric element 131 is higher than the resonance frequency of the second piezoelectric element 132. Therefore, the linear ultrasonic phased array image generated by using the first piezoelectric element 131 has a characteristic that a resolution (resolution in a vertical direction in FIGS. 3 and 4) in an axial direction is increased as compared with the linear ultrasonic phased array image generated by using the second piezoelectric element 132, but a propagation distance is decreased, and thus the propagation distance thereof is short.

[Third Operation Mode]

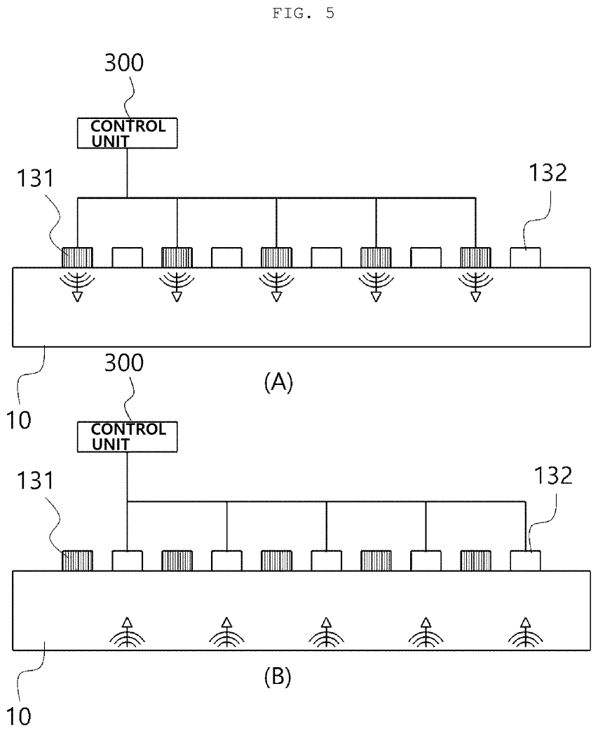

In the third operation mode according to the present invention illustrated in FIG. 5, a non-linear ultrasonic phased array image is generated by using both of the first piezoelectric element 131 and the second piezoelectric element 132.

For the operation in the above-described third operation mode, the control unit 300 applies an operation signal to the first piezoelectric element 131 to excite the first piezoelectric element 131, and the first piezoelectric element 131 transmits an ultrasonic signal to the object to be inspected 10 as illustrated in FIG. 5A. Here, ultrasonic signals applied to the first piezoelectric element 131 may have a predetermined phase difference, similarly to the first and second operation modes described above. However, the present invention is not limited thereto.

The ultrasonic signal transmitted from the first piezoelectric element 131 is transmitted through the object 10 to be inspected, and is reflected from the backwall (the distal end of the object to be inspected) of the object 10 to be inspected. The control unit 300 applies an operation signal to cause the second piezoelectric element 132 to receive the ultrasonic signal reflected from the backwall of the object 10 to be inspected, and then transmits the received ultrasonic signal to the portable imaging unit 200. The resonance frequency f1 of the first piezoelectric element 131 is n times the resonance frequency f2 of the second piezoelectric element 132 (n is a positive integer), and thus the ultrasonic signal received by the second piezoelectric element 132 is an n-th order higher harmonic signal.

The higher harmonic signal received by the second piezoelectric element 132 is transmitted to the portable imaging unit 200, and the portable imaging unit 200 outputs a non-linear higher harmonic phased array image with reference to the received ultrasonic signal and the operation signal applied from the control unit 300 to the first piezoelectric element 131. In the higher harmonic phased array image, a crack that may not be detected by a general linear phased array image may be detected. Specifically, in a case where an internal material of a structure is deformed due to an external force or stress, a subtle change of the material may be detected in the non-linear higher harmonic phased array image.

[Fourth Operation Mode]

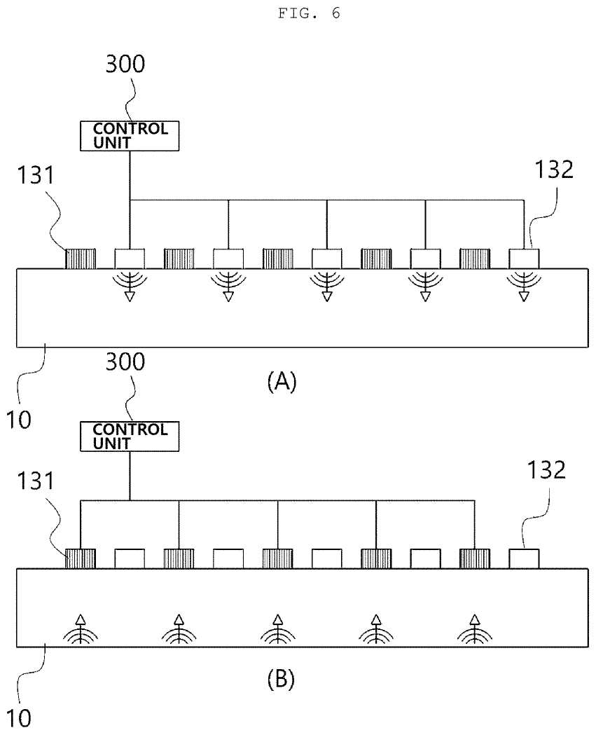

In the fourth operation mode according to the present invention illustrated in FIG. 6, a non-linear ultrasonic phased array image is generated by using both of the first piezoelectric element 131 and the second piezoelectric element 132.

The fourth operation mode according to the present invention is an operation mode in which a non-linear subharmonic phased array image is generated, unlike the third operation mode. To this end, although both of the first piezoelectric element 131 and the second piezoelectric element 132 are used similarly to the third operation mode, the piezoelectric elements are used in a reverse manner to the third operation mode.

Specifically, as illustrated in FIG. 6, the control unit 300 applies an operation signal to the second piezoelectric element 132 to transmit an ultrasonic signal to the object 10 to be inspected, and applies an operation signal to the first piezoelectric element 131 to receive an ultrasonic signal that is reflected and incident again. The resonance frequency f1 of the first piezoelectric element 131 is n times the resonance frequency f2 of the second piezoelectric element 132, and thus the ultrasonic signal received by the first piezoelectric element 131 is an n-th order subharmonic signal of the resonance frequency f1, and the portable imaging unit 200 may generate and output a non-linear subharmonic phased array image by using the received n-th order subharmonic signal. Similarly to the subharmonic phased array image, a crack that may not be detected by a general linear phased array image may be detected in the subharmonic phased array image.

Specifically, in a case of a closed defect that is caused due to elasticity of a material of the object to be inspected when the defect is generated in the object to be inspected, the ultrasonic wave is usually transmitted through the closed defect in linear image, whereas, the ultrasonic signal from the closed defect in a non-linear subharmonic phased array image, thereby enabling detection of the closed defect.

In the first and second operation modes described above, a linear subharmonic phased array image may be obtained. Therefore, the intensity of the ultrasonic signal applied from each piezoelectric element is immaterial. Therefore, the piezoelectric elements transmitting the ultrasonic signal in the first and second operation modes are sequentially excited and transmit the ultrasonic signal, or may transmit the ultrasonic signal through parallel excitation in which the piezoelectric elements are excited at the same time. In a case where the piezoelectric elements are excited at the same time, an ultrasonic signal with a higher intensity may be generated. Unlike the first and second operation modes, in the third and fourth operation modes, a non-linear subharmonic phased array image is obtained, and thus there is a need to generate an ultrasonic signal with a higher intensity. Therefore, in the third and fourth operation modes, a signal may be obtained by using only parallel excitation in which one type of piezoelectric elements of the first and second piezoelectric elements that are alternately arranged are excited at the same time, and then the signal may pass through a band pass filter with a desired frequency as a center frequency to thereby obtain a non-linear subharmonic phased array image by a time delay and sum method. In a case of using the third and fourth operation modes, although not illustrated, the complex multi-frequency ultrasonic phased array imaging device according to the present invention may further include the band pass filter mounted between the portable imaging unit and a piezoelectric element that receives an ultrasonic signal of the first and second piezoelectric elements, the ultrasonic signal being reflected from the backwall of the object to be inspected.

### Second Exemplary Embodiment

Hereinafter, a complex multi-frequency ultrasonic phased array imaging device according to a second exemplary embodiment of the present invention will be described in detail.

The complex multi-frequency ultrasonic phased array imaging device according to the second exemplary embodiment of the present invention includes the same components as those of the first exemplary embodiment, except for vibrators included in a vibrator unit, that is, piezoelectric elements. Therefore, in the second exemplary embodiment of the present invention, the piezoelectric elements included in the vibrator unit will be mainly described, and it is regarded that components that are not described below are the same between the first exemplary embodiment and the second exemplary embodiment.

According to the second exemplary embodiment of the present invention, the vibrator unit includes first to third piezoelectric elements having different resonance frequencies, respectively. When a resonance frequency of the first piezoelectric element is f1, a resonance frequency of the second piezoelectric element is f2, and a resonance frequency of the third piezoelectric element is f3, f1 may be a positive integer multiple of f2, f3 may be a positive integer multiple of f2, and it is assumed hereinafter that f1=2f2=4f2.

According to the second exemplary embodiment of the present invention, the first piezoelectric element, the second piezoelectric element, and the third piezoelectric element may be sequentially arranged in a repeated manner, and this is to obtain both a harmonic signal and a subharmonic signal by transmitting an ultrasonic signal using only one of the first piezoelectric element, the second piezoelectric element, or the third piezoelectric element, and receiving, by the remaining piezoelectric elements, an ultrasonic signal reflected from an object to be inspected.

For example, in a case where a control unit inputs an operation signal to the second piezoelectric element to excite the second piezoelectric element, the first piezoelectric element obtains a subharmonic signal and the third piezoelectric element obtains a higher harmonic signal, such that a second-order subharmonic image and a second-order higher harmonic image may be obtained, respectively. On the contrary, in a case where the third piezoelectric element transmits an ultrasonic signal, and the first and second piezoelectric elements receive an ultrasonic signal, a second-order higher harmonic signal and fourth-order higher harmonic signal may be obtained.

The present invention is not limited to the abovementioned exemplary embodiments, but may be variously applied, and may be variously modified without departing from the gist of the present invention claimed in the claims.

### DETAILED DESCRIPTION OF MAIN ELEMENTS

100: Transducer
110: Acoustic lens
120: Front matching layer
130: Vibrator unit
131: First piezoelectric element
132: Second piezoelectric element
133: Protective film
134: Wire
140: Back layer
200: Portable imaging unit
300: Control unit

1. A complex multi-frequency ultrasonic phased array imaging device comprising:
a transducer configured to transmit a phased array ultrasonic signal to an object to be inspected, receive an ultrasonic signal reflected from the object to be inspected, and include at least one first piezoelectric element having a high resonance frequency and at least one second piezoelectric element having a resonance frequency lower than that of the first piezoelectric element;
a control unit configured to apply an operation signal to the transducer to control operations of the first piezoelectric element and the second piezoelectric element; and
a portable imaging unit configured to calculate the operation signal applied from the control unit and the ultrasonic signal received by the transducer as a delay-sum for a phased array image to output the received ultrasonic signal as a phased array image.

2. The complex multi-frequency ultrasonic phased array imaging device of claim 1, wherein a plurality of first piezoelectric elements and a plurality of second piezoelectric elements are arranged in a predetermined pattern.

3. The complex multi-frequency ultrasonic phased array imaging device of claim 2, wherein the first piezoelectric element and the second piezoelectric element are alternately arranged.

4. The complex multi-frequency ultrasonic phased array imaging device of claim 1, wherein the resonance frequency of the first piezoelectric element is a positive integer multiple of the resonance frequency of the second piezoelectric element.

5. The complex multi-frequency ultrasonic phased array imaging device of claim 1, wherein the control unit applies the operation signal to the transducer to control only one of the first piezoelectric element or the second piezoelectric element to transmit and receive the ultrasonic signal.

6. The complex multi-frequency ultrasonic phased array imaging device of claim 1, wherein the control unit applies the operation signal to the transducer to control one of the first piezoelectric element or the second piezoelectric element to transmit the ultrasonic signal, and to control the other piezoelectric element that does not transmit the ultrasonic signal to receive the reflected ultrasonic signal.

7. The complex multi-frequency ultrasonic phased array imaging device of claim 6, wherein the portable imaging unit outputs a harmonic phased array image in a case where the first piezoelectric element transmits the ultrasonic signal and the second piezoelectric element receives the ultrasonic signal.

8. The complex multi-frequency ultrasonic phased array imaging device of claim 6, wherein the portable imaging unit outputs a subharmonic phased array image in a case where the second piezoelectric element transmits the ultrasonic signal and the first piezoelectric element receives the ultrasonic signal.
